(19) United States
(12) Patent Application Publication
(10) Pub. No.: US 2017/0197298 A1
(43) Pub. Date: Jul. 13, 2017

(54) STEPLESS WRENCH WITH TOOTHLESS DRIVE

(71) Applicant: JUNG-CHI YU, Taichung City (TW)

(72) Inventor: JUNG-CHI YU, Taichung City (TW)

(21) Appl. No.: 15/240,160

(22) Filed: Aug. 18, 2016

(30) Foreign Application Priority Data
Jan. 7, 2016 (TW) 105100437

(51) Int. Cl. B25B 13/46; B25B 23/00

(52) U.S. Cl. CPC B25B 13/462; B25B 23/0035

(57) ABSTRACT

A stepless wrench includes a wrench head, a toothless drive, an overrunning mechanism. The wrench head has a central bore and a cavity both defined in a front surface thereof. The cavity has a curved wall that has an engaging section and a releasing section. The toothless drive is rotatably carried in the central bore of the wrench head and has an outer cylindrical peripheral surface. A distance between the toothless drive and the curved wall of the cavity gradually decreases in a direction from the releasing section toward the engaging section. The overrunning mechanism has a roller and an elastic member both received in the cavity of the wrench head. The roller is biased by the elastic member, and has a diameter greater than a distance between the engaging section and the toothless drive such that the roller is sandwiched in between the toothless drive and the curved wall of the cavity.

### BACKGROUND OF THE INVENTION

1. Field of the Invention

The present invention relates to a wrench, and more particularly to a stepless wrench that employs a toothless drive.

2. Description of the Related Art

Ratchets are widely used in machinery and tools. A ratchet generally consists of a round gear with teeth and a pawl that engages the teeth in a manner to allow continuous linear or rotary motion in only one direction while preventing motion in the opposite direction.

Similar to a ratchet, a stepless wrench can also allow continuous linear or rotary motion in only one direction while preventing motion in the opposite direction. However, the stepless wrench has no gears, but incorporates a toothless drive and an overrunning mechanism to achieve the same function.

For example, one type of stepless wrench 800 is illustrated in FIGS. 20 and 21, which generally includes a wrench body 80, a toothless drive 81, a ball 82, a spring 83 and a screw plug 84. The wrench body 80 has a head that defines a central bore 801 for accommodation of the toothless drive 81. The wrench body 80 further defines a cone-shaped hole 802 in a side surface and an opening 803 at the junction between the cone-shaped hole 802 and the central bore 801. As best seen in FIG. 21, the ball 82 is disposed in a narrow end of the cone-shaped hole 802 adjacent to the opening 803 and is biased by the spring 83. The screw plug 84 is located at the other end of the cone-shaped hole 802 to confine the ball 82 and the spring 83 in the hole 802. It is noted that the ball 82 is partly exposed in the opening 803 to bear against the toothless drive 81. As shown above, the stepless wrench 800 is formed with the central bore 801 and the cone-shaped hole 802 that are defined in different sides, and the cone-shaped hole 802 and the opening 803 should be positioned and machined precisely. These make it difficult to manufacture the stepless wrench 800.

Another type of stepless wrench is shown in U.S. Pat. No. 870,151, which generally includes a wrench body, a toothless drive and two balls. In particular, a switch is built into the wrench body that allows the user to apply the ratchet-like action in either direction, as needed, to tighten or loosen a fastener. However, in this switchable stepless wrench, there are still holes or chambers defined in different sides of the wrench body for accommodation of the toothless drive and the balls. This makes it difficult to manufacture the stepless wrench, either.

### SUMMARY OF THE INVENTION

Accordingly, it is an object of the present invention to provide a stepless wrench that is relatively simple in structure and therefore can be easily made.

In one embodiment, the stepless wrench generally includes a wrench head, a toothless drive, an overrunning mechanism, a first blocking member and a second block member. The wrench head has a central bore and a cavity both defined in a front surface thereof. The cavity has a curved wall that faces the central bore. The curved wall has an engaging section and a releasing section. The toothless drive is rotatably carried in the central bore of the wrench head and has an outer cylindrical peripheral surface. Specifically, a distance between the outer cylindrical peripheral surface of the toothless drive and the curved wall of the cavity gradually decreases in a direction from the releasing section of the curved wall toward the engaging section of the curved wall. The overrunning mechanism has a roller and an elastic member both received in the cavity in the wrench head. The roller is biased by the elastic member, and has a diameter greater than a distance between the engaging section of the curved wall and the outer cylindrical peripheral surface of the toothless drive such that the roller is sandwiched in between the outer cylindrical peripheral surface of the toothless drive and the curved wall of the cavity. The first blocking member is disposed in a front opening of the central bore of the wrench head for confining the toothless drive to the central bore. And the second blocking member is disposed in a front opening of the cavity of the wrench head for confining the roller and the elastic member of the overrunning mechanism to the cavity.

In another embodiment, the stepless wrench generally includes a wrench head, a toothless drive and at least two overrunning mechanisms. The wrench head has a central bore and at least two cavities all in a front surface thereof. Each of the cavities has a curved wall that faces the central bore. The curved wall having an engaging section and a releasing section. In addition, the engaging sections of the curved wall extend from the respective releasing sections in clockwise or counterclockwise order. The toothless drive is rotatably carried in the central bore in the wrench head and has an outer cylindrical peripheral surface. Specifically, a distance between the outer cylindrical peripheral surface of the toothless drive and the curved wall of each cavity gradually decreases in a direction from the releasing section of the curved wall toward the engaging section of the curved wall. Each of the overrunning mechanisms has a roller and an elastic member both received in the respective cavity in the wrench head. The roller is biased by the elastic member, and has a diameter greater than a distance between the engaging section of the curved wall and the outer cylindrical peripheral surface of the toothless drive such that the roller is sandwiched in between the outer cylindrical peripheral surface of the toothless drive and the curved wall of the cavity.

In yet another embodiment, the stepless wrench includes a wrench head, a toothless drive, a pair of overrunning mechanisms, a switch mechanism, a first blocking member and a second blocking member. The wrench head has a central bore and a chamber both defined in a front surface thereof. The chamber includes a pair of cavities and a central room in the middle of the cavities. Each cavity has a curved wall that faces the central bore. The curved wall has an engaging section and a releasing section. The toothless drive is rotatably carried in the central bore in the wrench head and has an outer cylindrical peripheral surface. Specifically, a distance between the outer cylindrical peripheral surface of the toothless drive and the curved wall of each cavity gradually decreases in a direction from the releasing section of the curved wall toward the engaging section of the curved wall. The pair of overrunning mechanisms is received in the pair of cavities and each of the overrunning mechanisms has a roller and an elastic member in the respective cavity. The roller is biased by the elastic member, and has a diameter greater than a distance between the engaging section of the curved wall and the outer cylindrical peripheral surface of the toothless drive such that the roller is sandwiched in between the outer cylindrical peripheral surface of the toothless drive and the curved wall of the cavity. The switch mechanism is disposed in the central room of the chamber for selectively throwing one of the rollers out of contact with the toothless drive so that only the other roller is allowed to bear against the toothless drive. The first blocking member is disposed in a front opening of the central bore of the wrench head for confining the toothless drive to the central bore. And the second blocking member is disposed in a front opening of the chamber of the wrench head for confining the roller and the elastic member and the switch mechanism to the chamber.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 is a perspective view of a stepless wrench in accordance with a first embodiment of the present invention;

FIG. 2 is a front view of the stepless wrench shown in FIG. 1;

FIG. 3 is an exploded perspective view of the stepless wrench shown in FIG. 1;

FIG. 4 is a front view of a wrench body and a toothless drive of the stepless wrench shown in FIG. 1;

FIG. 5 illustrates that the stepless wrench of FIG. 1 is turned in a counterclockwise direction;

FIG. 6 illustrates that the stepless wrench of FIG. 1 is turned in a clockwise direction;

FIG. 7 is an exploded perspective view of a stepless wrench in accordance with a second embodiment of the present invention;

FIG. 8 is a perspective view of a stepless wrench in accordance with a third embodiment of the present invention;

FIG. 9 is an exploded perspective view of the stepless wrench shown in FIG. 8;

FIG. 10 is a front view, in partial cross-section, of the stepless wrench shown in FIG. 8;

FIG. 11 is a front view of a stepless wrench in accordance with a fourth embodiment of the present invention;

FIG. 12 is an exploded perspective view of the stepless wrench shown in FIG. 11;

FIG. 13 is a front view of a wrench body and a toothless drive of the stepless wrench shown in FIG. 11;

FIG. 14 is a cross-sectional view of the stepless wrench taken along the line XIV-XIV in FIG. 11;

FIG. 15 illustrates that the stepless wrench of FIG. 11 is turned in a counterclockwise direction when a lever is turned to the right;

FIG. 16 illustrates that the stepless wrench of FIG. 11 is turned in a clockwise direction when the lever is turned to the right;

FIG. 17 illustrates that the stepless wrench of FIG. 11 is pivoted in a counterclockwise direction when a lever is turned to the left;

FIG. 18 illustrates that the stepless wrench of FIG. 11 is pivoted in a clockwise direction when the lever is turned to the left;

FIG. 19 is a perspective view of a stepless wrench in accordance with a fifth embodiment of the present invention; and

FIGS. 20 and 21 are directed to a prior art stepless wrench.

### DETAILED DESCRIPTION OF EMBODIMENTS

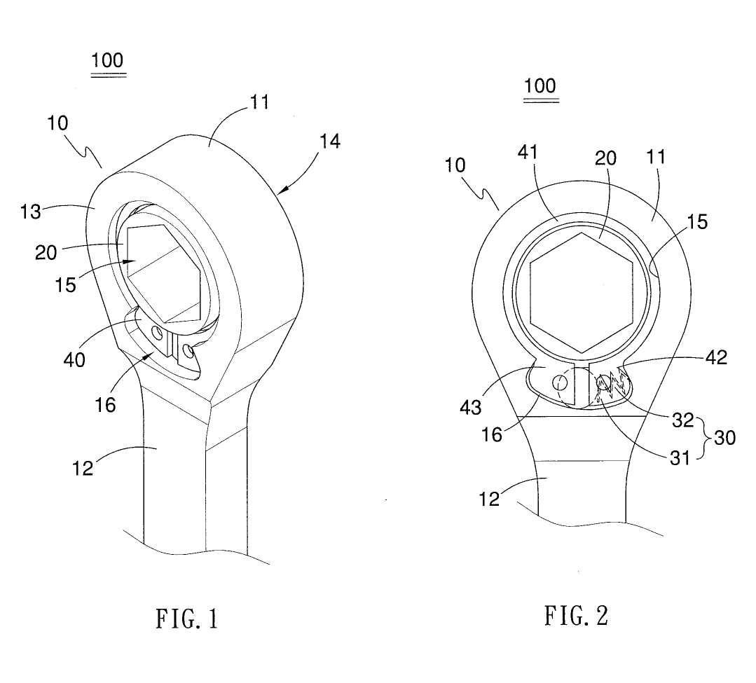

Referring to FIGS. 1-6, there is shown a first embodiment of the stepless wrench 100, which generally includes a wrench body 10, a toothless drive 20, an overrunning mechanism 30 and a retaining ring 40.

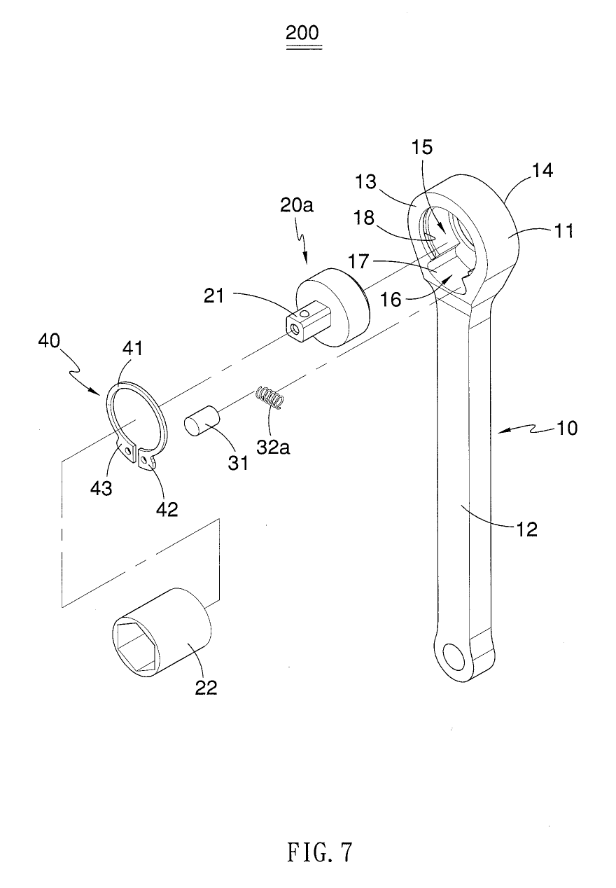

As shown in FIGS. 1 and 2, the wrench body 10 has a head 11 and a handle 12. The wrench head 11 has a central bore 15 extending between a front surface 13 and a rear surface 14 of the head 11. The toothless drive 20 has an outer cylindrical peripheral surface 201 and is rotatably carried in the central bore 15 of the wrench head 11. In this embodiment, the toothless drive 20 is directed to a socket drive configured to receive the head of a hex nut, for example. However, in another example, the toothless drive 20a may be an insert configured with a protruding portion 21 of the type known to connect to an adapter of a conventional socket 22, as shown in FIG. 7.

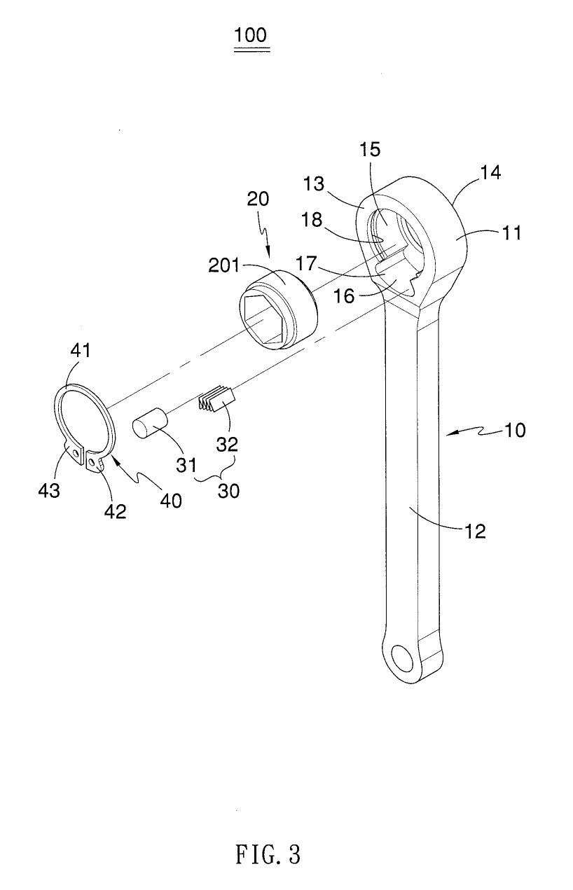

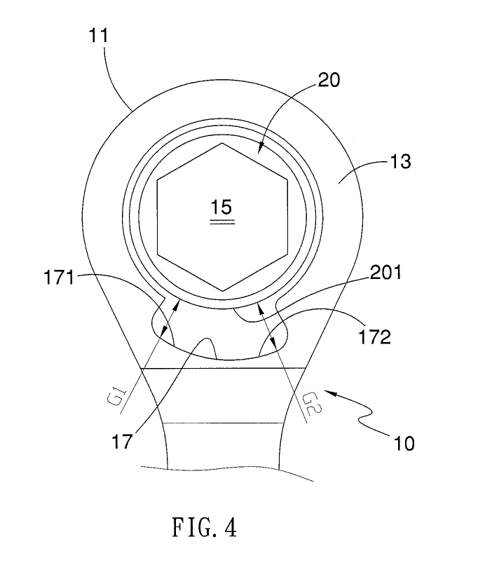

Referring to FIG. 3, the wrench head 11 further defines a cavity 16 in the front surface 13 thereof adjacent to the central bore 15. As best seen in FIG. 4, the cavity 16 has a curved wall 17 that faces the central bore 15 and has an engaging section 171 and a releasing section 172, as shown in FIG. 4. A distance between the outer cylindrical peripheral surface 201 of the toothless drive 20 and the curved wall 17 of the cavity 16 gradually decreases in a direction from the releasing section 172 of the curved wall 17 toward the engaging section 171 of the curved wall 17. For example, a gap G1 between the engaging section 171 and the outer cylindrical peripheral surface 201 of the toothless drive 20 is smaller than a gap G2 between the releasing section 172 and the outer cylindrical peripheral surface 201 of the toothless drive 20.

The overrunning mechanism 30 includes a roller 31 and an elastic member 32 both received in the cavity 16 of the wrench head 11. The roller 31 is rollable between the engaging section 171 and the releasing section 172. The elastic member 32 is located in the releasing section 172, and has one end abutting against a side wall of the cavity 16 and the other end urging the roller 31 against the toothless drive 20. Moreover, the roller 31 has a diameter greater than a distance between the engaging section 171 of the curved wall 17 and the outer cylindrical peripheral surface 201 of the toothless drive 20 such that the roller 31 is sandwiched in between the outer cylindrical peripheral surface 201 of the toothless drive 20 and the curved wall of the cavity 17. It is noted that the elastic member 32 is a compressed folded plate in this embodiment; however, the elastic member 32a may be a compressed spring instead, as shown in FIG. 7.

As compared to the conventional stepless wrench, the stepless wrench 100 of the present invention has its central hole and its cavity both formed in the front surface 13 of the wrench head 11. Thus, the hole-making in the wrench body 10 of the stepless wrench 100 can be performed a lot easier.

Referring to FIGS. 2 and 3, the retaining ring 40 includes a C-shaped ring body 41 and a pair of enlarged end portions 42, 43 at opposite ends of the ring body 41. On the other hand, the wrench head 11 further defines an annular groove 18 in an inner wall of the central bore 15 and closer to the front opening of the central bore 15. The C-shaped ring body 41 is partly engaged in the annular groove 18 to block the toothless drive 20 from falling off the central bore 15. The pair of the enlarged end portions 42, 43 is shaped in compliance with the geometry of the cavity 16, and engaged in the cavity 16. In particular, one of the end portions 42 is configured to block a portion of one ball 31 and the elastic member 32 while the other end portion 43 is configured to block the rest portion of the ball 31. It is preferable that a junction between the ball 31 and the elastic member 32 is completely covered by the first end portion 42 for security. With the elasticity of the retaining ring 40, the ball 31 and the elastic member 32 can be easily assembled to the wrench head 11 and no fasteners will be needed.

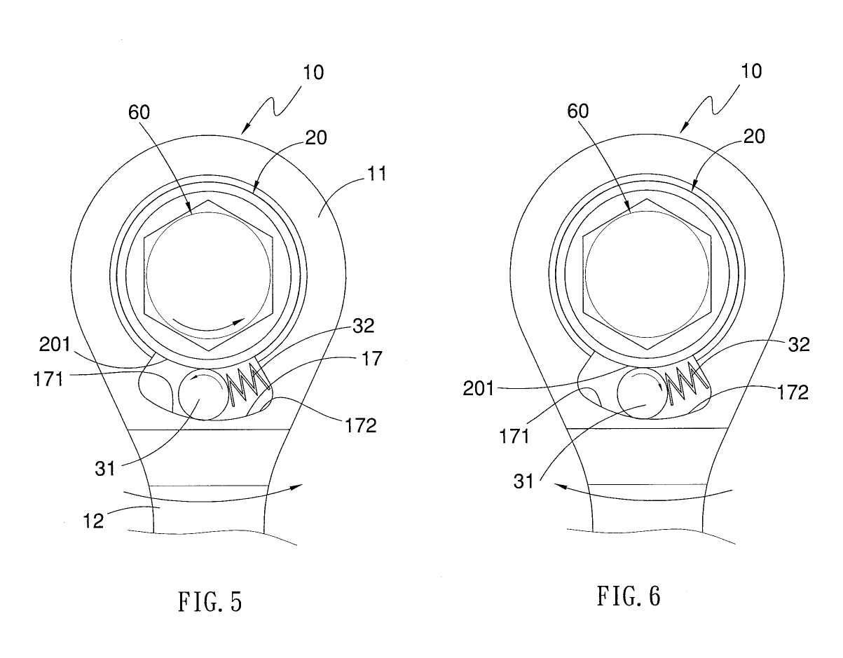

In ordinary operation, when the handle 12 is turned in a counterclockwise direction as indicated by the arrow in FIG. 5, the roller 31 is forced toward the engaging section 171 of the curved wall 17, where it wedges tightly between the toothless drive 20 and the curved wall 17 of the wrench body 10. The toothless drive 20 is thus secured to the wrench body 10 and rotates therewith. The roller 31 is at all times urged toward the wedging position by the elastic member 32. In contrast, when the handle 12 is rotated in a clockwise direction as indicated by the arrow in FIG. 6, the roller 31 is urged toward the releasing section 172 of the curved wall 17 against the elastic member 32. Since the roller 31 then lies at a point where the gap between the toothless drive 20 and the curved wall 16 is larger, free relative rotation of the toothless drive 20 and the wrench body 10 is permitted. Once the turning action of the toothless drive 20 stops, the roller 31 will be again biased by the elastic member 32 against the toothless drive 20.

As shown in FIG. 4, the distance between the engaging section 171 of the curved wall 17 and the outer cylindrical peripheral surface 201 of the toothless drive 20 gradually decreases. After long-term use of the stepless wrench 100, the roller 31 may become worn out and unable to be wedged tightly in the wedged position between the engaging section 171 and the toothless drive 20. In this case, the roller 31 may move further to another wedged position and remain stuck well in between the engaging section 171 and the toothless drive 20.

It should be noted that the roller 31 may be cylindrical as a pin as in this embodiment or a ball as in other example, not shown. In this embodiment, the pin roller 31 and the toothless drive 20 are respectively disposed in the cavity 16 and the central bore 15 in the wrench head 11, and the pin roller 31 has an axis parallel to that of the toothless drive 20. As such, the pin roller 31 forms an upper line contact with the outer cylindrical peripheral surface 201 of the toothless drive 20, and a lower line contact with the engaging section 171 of the curved wall 17 of the cavity 16. Thus, less stress may be generated as compared to the case where the pin roller 31 is replaced by a ball roller.

With reference to FIG. 7, there is shown a second embodiment of the stepless wrench 200. The stepless wrench 200 is substantially identical to the stepless wrench 100 in the first embodiment, except that the toothless drive 20a is the insert configured with the protruding portion 21 to connect to the socket 22; and the elastic member 32a is a compressed spring. In view of the similarity between the first and second embodiments, the descriptions of the parts of the second embodiment that are identical to the parts of the first embodiment will be omitted for the sake of brevity.

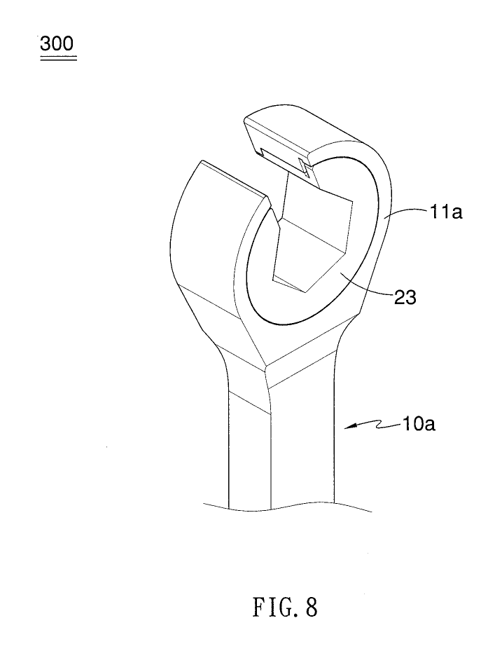

With reference to FIGS. 8 to 10, there is shown a third embodiment of the stepless wrench 300. The stepless wrench 300 of the third embodiment is substantially identical to that of the first embodiment, except that there is more than one overrunning mechanism in the stepless wrench 300 and a C-shaped retaining ring 40 is covered by a flange 23 of the toothless drive 20b and hidden in the wrench head 11a.

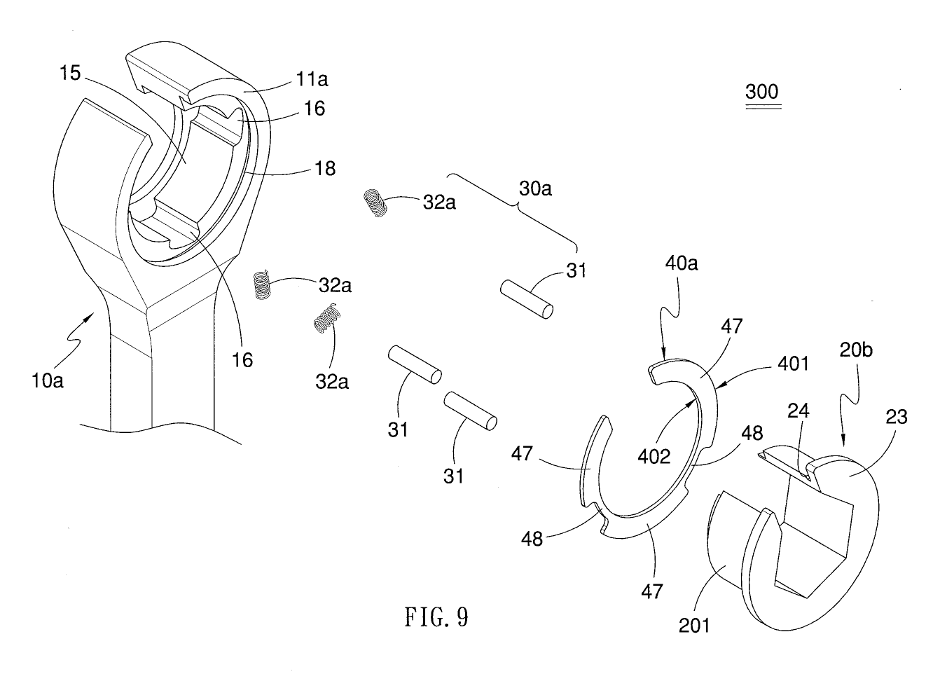

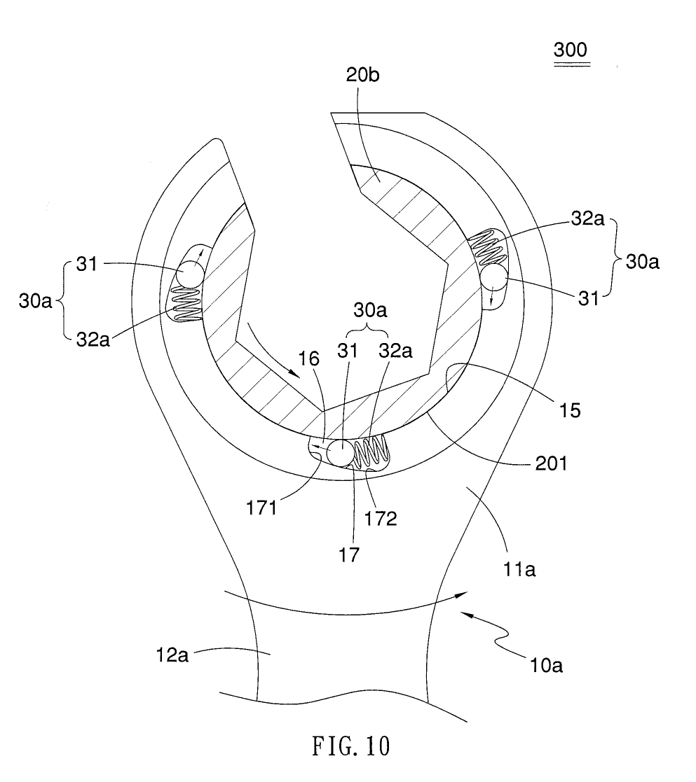

Specifically, as shown in FIG. 9 or 10, the wrench head 11 a has a central bore 15 and three cavities 16 surrounding the central bore 15 for accommodation of the three overrunning mechanisms 30a. Each of the cavities 16 has a curved wall 17 that faces the central bore 15, and the curved wall 17 has an engaging section 171 and a releasing section 172. And, the engaging sections 171 extend from the respective releasing sections 172 in clockwise order. The engaging sections 171 is shown here as arranged in clockwise order, yet it is recognized that the opposite configuration may be employed to carry out the invention

The toothless drive 20 is rotatably carried in the central bore 15 in the wrench head 11a and has an outer cylindrical peripheral surface 201. A distance between the outer cylindrical peripheral surface 201 of the toothless drive 20b and the curved wall 17 of each cavity 16 gradually decreases in a direction from the releasing section 172 toward the engaging section 171.

Similar to the overrunning mechanisms 30 of the stepless wrench 100 of the first embodiment, each of the overrunning mechanisms 30a includes a cylindrical roller 31 and an elastic member 32a both received in the respective cavity 16 in the wrench head 11a. Each roller 31 has an axis parallel to that of the toothless drive 20b and is biased by the elastic member 32a. Moreover, the roller 31 has a diameter greater than a distance between the engaging section 171 of the curved wall 17 and the outer cylindrical peripheral surface 201 of the toothless drive 20 such that the roller 31 is sandwiched in between the outer cylindrical peripheral surface 201 of the toothless drive 20 and the curved wall 17 of the cavity 16.

In particular, the toothless drive 20b is formed with a flange 23 at one end and defines an annular groove 24 in the outer cylindrical peripheral surface 201 and adjacent to the flange 23, as shown in FIG. 9. On the other hand, the wrench head 11a further defines an annular groove 18 in an inner wall of the central bore 15 and closer to the front opening of the central bore 15. In addition, a C-shaped retaining ring 40a is employed to connect both the toothless drive 20b and the overrunning mechanisms 30a to the wrench head 11a.

Specifically, the C-shaped retaining ring 40a has an outer peripheral edge 401 engaged in the annular groove 18 in the inner wall of the central bore 15 for blocking the overrunning mechanisms 30a, and an inner peripheral edge 402 engaged in the annular groove 24 of the toothless drive 20b for grasping the toothless drive 20b from falling off the central bore 15 of the wrench head 11a. The flange 23 of the toothless drive 20b serves as a lid to hide the C-shaped retaining ring 40a within the wrench head 11a. It is preferable that the C-shaped retaining ring 40a has three wide sections 47 for blocking the rollers 31 and an elastic members 32a, and two narrow sections 48 for increasing the flexibility of the C-shaped retaining ring 40a in order to facilitate the peripheral edge of the retaining ring 40a be fed into the annular groove 18 in the inner wall of the central bore 15.

As shown in FIG. 10, in this embodiment, the engaging sections 171 extend from the respective releasing sections 172 in clockwise order. In ordinary operation, when the handle 12a is turned to the right, the toothless drive 20b will be turned in the same direction, because each of the rollers 31 becomes wedged between the toothless drive 20b and the curved wall 17 of the cavity 16. However, when the handle 12a is turned toward the left, each of the rollers 31 does not become thus wedged and movement of the handle 12a does not turn the toothless drive 20b. Thus, only rotation of the wrench body 10a in the counterclockwise direction turns the toothless drive 20b, yet it is recognized that, in another example where the engaging sections 171 extend from the respective releasing sections 172 in counterclockwise order, the handle 12a should be turned to the left to move the toothless drive 20b.

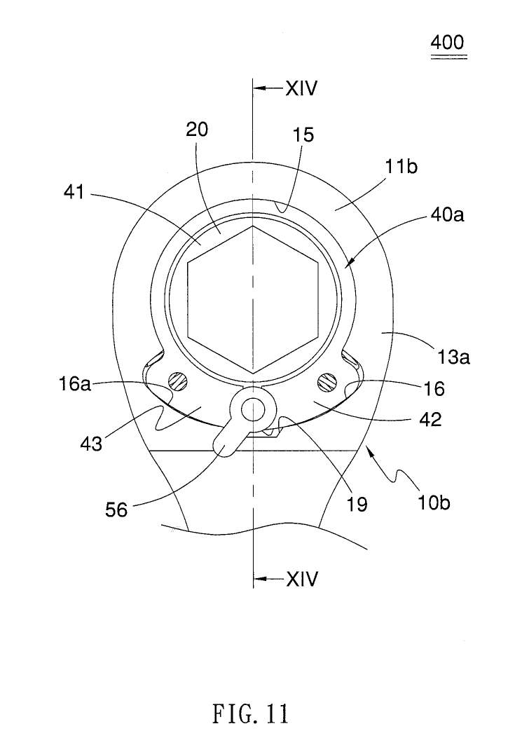

With reference to FIGS. 11 to 17, there is shown a fourth embodiment of the stepless wrench 400. The stepless wrench 400 generally includes a wrench body 10b, a toothless drive 20, a pair of overrunning mechanisms 30a, a retaining ring 40b and a switch mechanism 50.

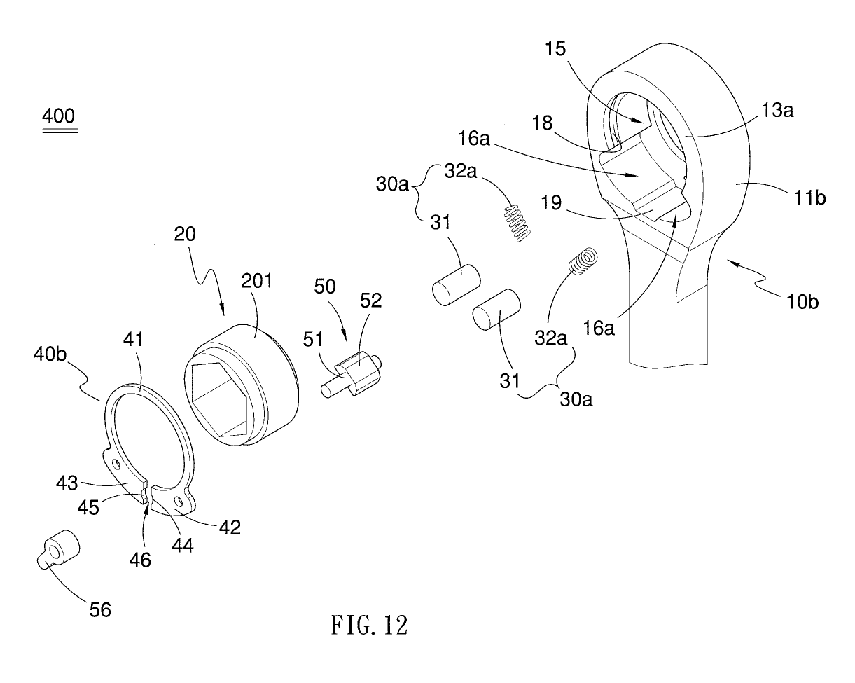

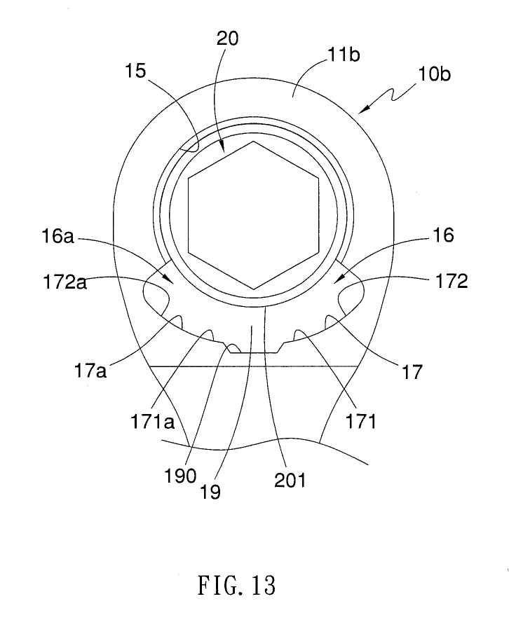

Firstly, as shown in FIG. 11 or 12, the wrench body 10b has a head 11b that has a central bore 15 extending between a front surface 13a and a rear surface 14b of the head 11b. The toothless drive 20 is rotatably carried in the central bore 15 of the wrench head 11b. The wrench head 11 further defines a chamber (not numbered) in the front surface 13 thereof adjacent to the central bore 15. The chamber includes a pair of cavities 16, 16a and a central room 19 in the middle of the cavities 16, 16a. The two cavities 16, 16a are bilateral symmetric and each has a curved wall 17 (17a) that faces the central bore 15. The curved wall 17 (17a) has an engaging section 171 (171a) and a releasing section 172 (172a). Moreover, the central room 19 further includes a positioning recess 190 in a wall thereof facing upward the central bore 15, as best seen in FIG. 13.

The toothless drive 20 is rotatably carried in the central bore 15 in the wrench head 11b and has an outer cylindrical peripheral surface 201. A distance between the outer cylindrical peripheral surface 201 of the toothless drive 20 and the curved wall 17 (17a) of each cavity 16 (16a) gradually decreases in a direction from the releasing section 172 (172a) of the curved wall 17 (17a) toward the engaging section 171 (171a) of the curved wall 17 (17a).

The pair of the overrunning mechanisms 30a is received in the pair of cavities 16 (16a), and each of the overrunning mechanisms 30a has a cylindrical roller 31 and an elastic member 32a in the respective cavity 16 (16a). Moreover, the roller 31 is biased by the elastic member 32a, and has a diameter greater than a distance between the engaging section 171 (171a) of the curved wall 17 (17a) and the outer cylindrical peripheral surface 201 of the toothless drive 20 such that the roller 31 is sandwiched in between the outer cylindrical peripheral surface 201 of the toothless drive 20 and the curved wall 17 (17a) of the cavity 16 (16a).

The switch mechanism 50 is substantially disposed in the central room 19 of the chamber for selectively throwing one of the rollers 31 out of contact with the toothless drive 20 so that only the other roller 31 is allowed to bear against the toothless drive 20. Specifically, as shown in FIG. 12, the switch mechanism 50 includes a shaft 51, a stopper 52 mounted around the shaft 51 and a lever 56 formed on an end of the shaft 51. The shaft 51 is pivotably disposed in the central room 19 of the wrench head 11b. The stopper 52 has two wings for blocking either one of the two rollers 31. The lever 56 is disposed outside the wrench head 11b to be accessed by a user.

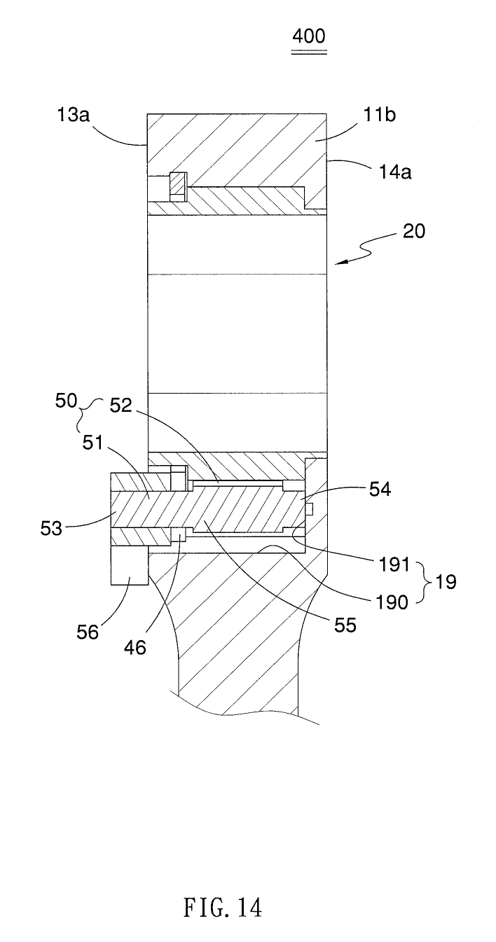

More specifically, as shown in FIG. 14, the shaft 51 has a body 55 and two opposite ends 53, 54. One end 53 of the shaft 51 projects outside the wrench head 11b and is engaged with the lever 56. The stopper 52 is integrally formed on the body 55 of the shaft 51 in a manner that the wings of the stopper 52 can rotates with the shaft 51 to push one of the rollers 31 aside. While it is preferable that the stopper 52 is integrally formed on the shaft 51, those of skill in the art will appreciate from this disclosure that the stopper 52 can be a discrete part that is fastened to the shaft 51 without departing from the scope of the present invention.

Referring back to FIG. 12, the wrench head 11b further defines an annular groove 18 in an inner wall of the central bore 15 and closer to the front opening of the central bore 15. The retaining ring 40b includes a C-shaped ring body 41 and two enlarged end portions 42, 43. The C-shaped ring body 41 of the retaining ring 40b is disposed in a front opening of the central bore 15 of the wrench head 11b and is partly engaged in the annular groove 18 in the inner wall of the central bore 15 for confining the toothless drive 20 to the central bore 15. The two enlarged end portions 42, 43 of the retaining ring 40b are together disposed in a front opening of the chamber (16, 16a, 19) for confining the rollers 31, the elastic members 32a and the switch mechanism 50 to the chamber.

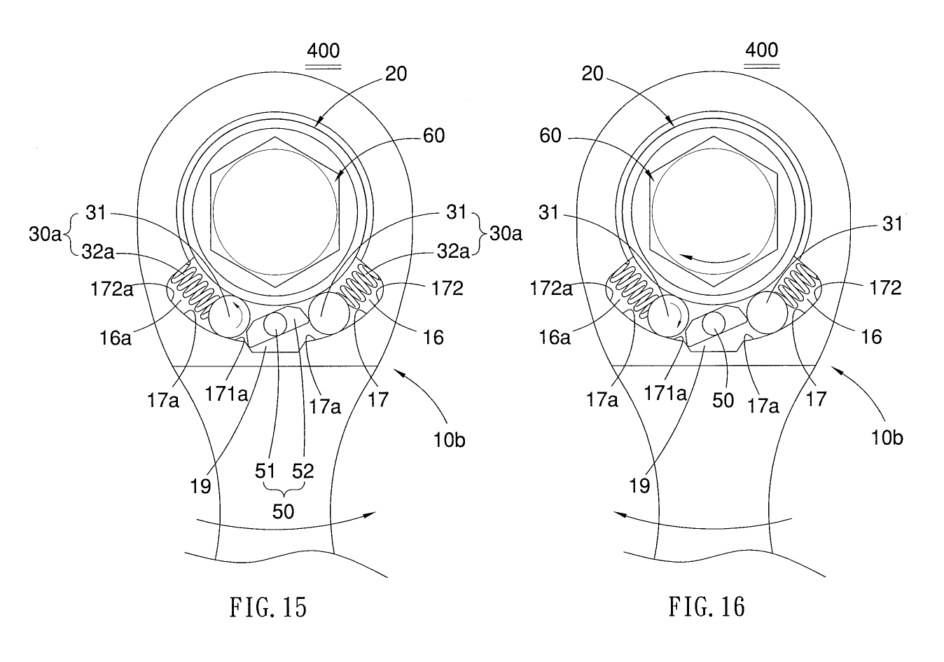

More specifically, as shown in FIGS. 11 and 15, the first end portion 42 of the retaining ring 40b is disposed in the cavity 16 and occupies part of the central room 19, appeared at the right-hand side of FIG. 11, so as to block the roller 31, the elastic member 32a and part of the switch mechanism 50 on the right, as shown in FIG. 15. Similarly, the second end portion 43 of the retaining ring 40b is disposed in the cavity 16a and occupies part of the central room 19, appeared at the left-hand side of FIG. 11, so as to block the roller 31, the elastic member 32a and the other part of the switch mechanism 50 on the left, as shown in FIG. 15.

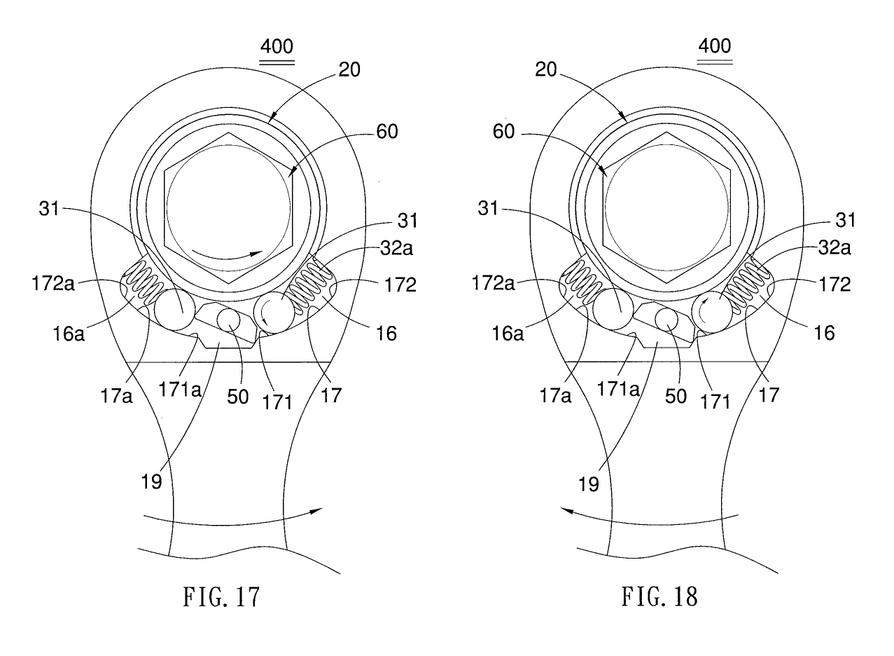

Furthermore, as shown in FIG. 12, the first end portion 42 of the retaining ring 40b has a side edge 44 located in the central room 19, and the second end portion 43 of the retaining ring 40b has an opposed side edge 45 also located in the central room 19. The two side edges 44, 45 of the two end portions 42, 43 together define a passageway 46 through which the end portion 53 of the shaft 51 of the switch mechanism 50 passes for engagement with the lever 56. The other end portion 54 of the shaft 51 bears against an rear wall 191 of the central room 19, as depicted in FIG. 14. In this manner, the lever 56 of the switch mechanism 50 can be turned to turn the shaft 51 as well as the stopper 52 to the right or to the left, as shown in FIG. 15 or 17, for selectively throwing one of the rollers 31 out of contact with the toothless drive 20 so that only the other roller 31 is allowed to bear against the toothless drive 20.

In ordinary operation, once the stopper 52 of the switch mechanism 50 is turned to the right, as shown in FIG. 15, the roller 31 on the right is pushed away toward the releasing section 172 and out of contact with the toothless drive 20. In this condition, when the wrench body 10b is turned in a counterclockwise direction, the roller 31 on the left is urged toward the releasing section 172a of the curved wall 17a against the elastic member 32a, free relative rotation of the toothless drive 20 and the wrench body 10b is permitted, and therefore the movement of the wrench body 10b does not turn the toothless drive 20. In contrast, when the wrench body 10b is rotated in a clockwise direction as shown in FIG. 16, the roller 31 on the left is forced toward the engaging section 171a of the curved wall 17a, where it wedges tightly between the toothless drive 20 and the curved wall 17a of the wrench body 10b. The toothless drive 20 is thus secured to the wrench body 10b and rotates therewith.

However, if the stopper 52 of the switch mechanism 50 is turned to the left, as shown in FIG. 17, the roller 31 on the left is pushed away toward the releasing section 172a and out of contact with the toothless drive 20. In this condition, when the wrench body 10b is turned in a counterclockwise direction, the roller 31 on the right is forced toward the engaging section 171 of the curved wall 17, where it wedges tightly between the toothless drive 20 and the curved wall 17 of the wrench body 10b. The toothless drive 20 is thus secured to the wrench body 10b and rotates therewith. In contrast, when the wrench body 10b is rotated in a clockwise direction as shown in FIG. 18, the roller 31 on the right is urged toward the releasing section 172 of the curved wall 17 against the elastic member 32a, free relative rotation of the toothless drive 20 and the wrench body 10b is permitted, and therefore the movement of the wrench body 10b does not turn the toothless drive 20.

In other words, if the switch mechanism 50 is turned to the right, as shown in FIG. 15 or 16, only rotation of the wrench body 10b in clockwise direction can turn the toothless drive 20 as well as the nut 60. However, if the switch mechanism 50 is turned to the left, as shown in FIG. 17 or 18, only rotation of the wrench body 10b in counterclockwise direction can turn the toothless drive 20 and the nut 60.

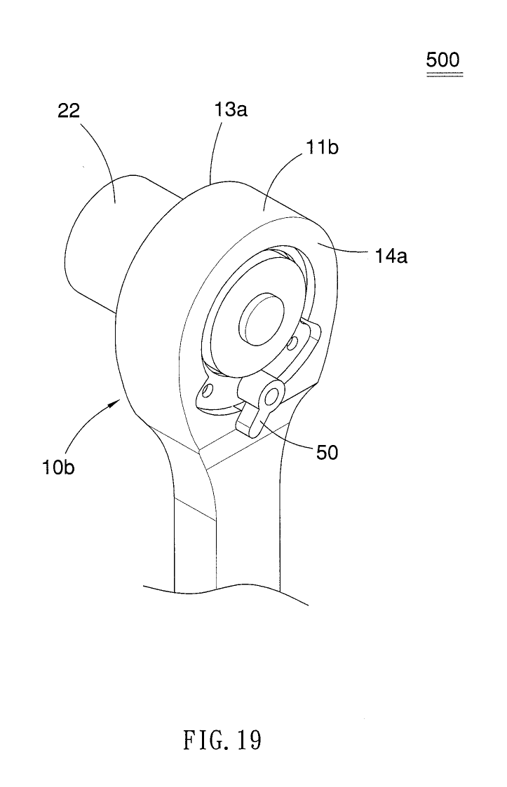

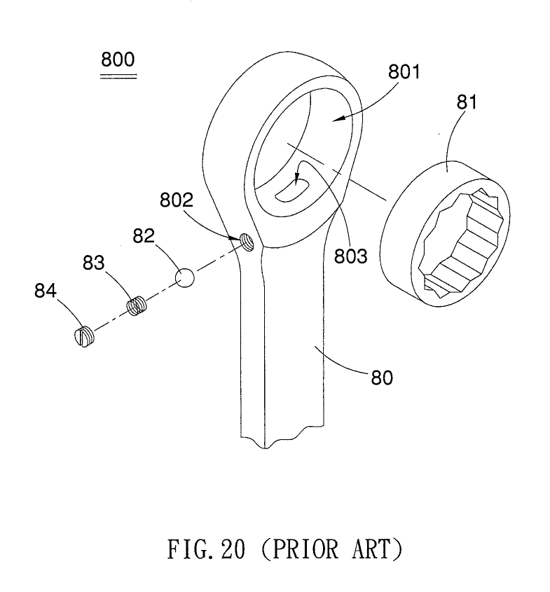

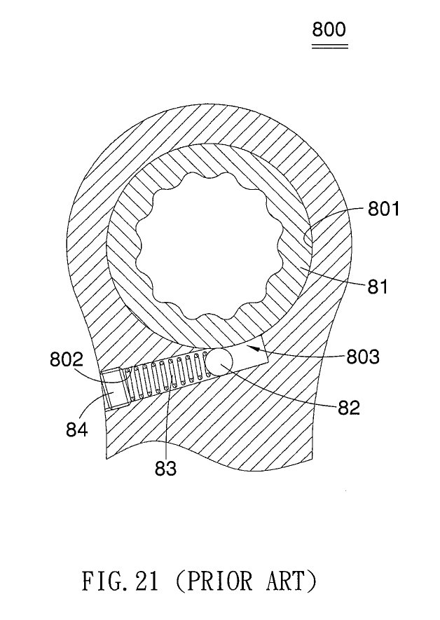

With reference to FIG. 19, a stepless wrench 500 is provided according to a fifth embodiment of the present invention. The stepless wrench 500 of the fifth embodiment is substantially identical to that of the fourth embodiment, except that the toothless drive (not shown) is replaced by the toothless drive 20a of the second embodiment as shown in FIG. 7 where a socket 22 is connected thereto; and the lever 56 of the fifth embodiment is mounted on a rear surface 14a of the wrench head 11b, rather than on the front surface 13a.

As described above, the present invention is directed to a stepless wrench with its central hole and its chamber or cavities all formed in the front surface of the wrench head. Thus, the stepless wrench can be made relatively easily.

It should be evident that this disclosure is by way of example and that various changes may be made by adding, modifying or eliminating details without departing from the fair scope of the teaching contained in this disclosure.

What is claimed is:

1. A stepless wrench, comprising:
a wrench head having a central bore and a cavity both defined in a front surface thereof, the cavity having a curved wall that faces the central bore, the curved wall having an engaging section and a releasing section;
a toothless drive rotatably carried in the central bore of the wrench head and having an outer cylindrical peripheral surface, wherein a distance between the outer cylindrical peripheral surface of the toothless drive and the curved wall of the cavity gradually decreases in a direction from the releasing section of the curved wall toward the engaging section of the curved wall;
an overrunning mechanism having a roller and an elastic member both received in the cavity in the wrench head, wherein the roller is biased by the elastic member, and has a diameter greater than a distance between the engaging section of the curved wall and the outer cylindrical peripheral surface of the toothless drive such that the roller is sandwiched in between the outer cylindrical peripheral surface of the toothless drive and the curved wall of the cavity;
a first blocking member disposed in a front opening of the central bore of the wrench head for confining the toothless drive to the central bore; and
a second blocking member disposed in a front opening of the cavity of the wrench head for confining the roller and the elastic member of the overrunning mechanism to the cavity.

2. A stepless wrench as recited in claim 1, wherein the roller is cylindrical in shape and has an axis parallel to that of the toothless drive.

3. A stepless wrench as recited in claim 1, wherein the wrench head further defines an annular groove in an inner wall of the central bore and closer to the front opening of the central bore; the first and second blocking members are together formed as a retaining ring in which the first blocking member is directed to a C-shaped ring body of the Retaining ring partly engaged in the annular groove in the inner wall of the central bore for blocking the toothless drive while the second blocking member is directed to two enlarged end portions of the retaining ring for blocking the roller and the elastic member of the overrunning mechanism.

4. A stepless wrench, comprising:
a wrench head having a central bore and at least two cavities all in a front surface thereof, each of the cavities having a curved wall that faces the central bore, the curved wall having an engaging section and a releasing section, wherein the engaging sections of the curved wall extend from the respective releasing sections in clockwise or counterclockwise order;
a toothless drive rotatably carried in the central bore in the wrench head and having an outer cylindrical peripheral surface, wherein a distance between the outer cylindrical peripheral surface of the toothless drive and the curved wall of each cavity gradually decreases in a direction from the releasing section of the curved wall toward the engaging section of the curved wall; and
at least two overrunning mechanisms each having a roller and an elastic member both received in the respective cavity in the wrench head, wherein the roller is biased by the elastic member, and has a diameter greater than a distance between the engaging section of the curved wall and the outer cylindrical peripheral surface of the toothless drive such that the roller is sandwiched in between the outer cylindrical peripheral surface of the toothless drive and the curved wall of the cavity.

5. A stepless wrench as recited in claim 4, wherein the roller of each overrunning mechanism is cylindrical in shape and has an axis parallel to that of the toothless drive.

6. A stepless wrench as recited in claim 4, further comprising a C-shaped retaining ring, wherein the wrench head further defines an annular groove in an inner wall of the central bore and closer to the front opening of the central bore; the toothless drive is formed with a flange at one end and defines an annular groove in the outer cylindrical peripheral surface and adjacent to the flange; the C-shaped retaining ring has an outer peripheral edge engaged in the annular groove in the inner wall of the central bore for blocking the overrunning mechanisms, and an inner peripheral edge engaged in the annular groove of the toothless drive for grasping the toothless drive from falling off the central bore of the wrench head; and the flange of the toothless drive serves as a lid to hide the C-shaped retaining ring within the wrench head.

7. A stepless wrench, comprising:
a wrench head having a central bore and a chamber both defined in a front surface thereof, the chamber includes a pair of cavities and a central room in the middle of the cavities, each cavity having a curved wall that faces the central bore, the curved wall having an engaging section and a releasing section;
a toothless drive rotatably carried in the central bore in the wrench head and having an outer cylindrical peripheral surface, wherein a distance between the outer cylindrical peripheral surface of the toothless drive and the curved wall of each cavity gradually decreases in a direction from the releasing section of the curved wall toward the engaging section of the curved wall;
a pair of overrunning mechanisms received in the pair of cavities and each of the overrunning mechanisms having a roller and an elastic member in the respective cavity, wherein the roller is biased by the elastic member, and has a diameter greater than a distance between the engaging section of the curved wall and the outer cylindrical peripheral surface of the toothless drive such that the roller is sandwiched in between the outer cylindrical peripheral surface of the toothless drive and the curved wall of the cavity;
a switch mechanism disposed in the central room of the chamber for selectively throwing one of the rollers out of contact with the toothless drive so that only the other roller is able to bear against the toothless drive;
a first blocking member disposed in a front opening of the central bore of the wrench head for confining the toothless drive to the central bore; and
a second blocking member disposed in a front opening of the chamber of the wrench head for confining the roller and the elastic member and the switch mechanism to the chamber.

8. A stepless wrench as recited in claim 7, wherein the wrench head further defines an annular groove in an inner wall of the central bore and closer to the front opening of the central bore; the first and second blocking members are together formed as a retaining ring in which the first blocking member is directed to a C-shaped ring body of the retaining ring partly engaged in the annular groove in the inner wall of the central bore for blocking the toothless drive while the second blocking member is directed to two enlarged end portions of the retaining ring for blocking the rollers, the elastic members and the switch mechanism.

9. A stepless wrench as recited in claim 7, wherein the switch mechanism includes a shaft pivotably mounted in the central room of the wrench head, a stopper mounted around the shaft with two wings to block either one of the two rollers, and a lever formed on an end of the shaft and disposed outside the wrench head.

10. A stepless wrench as recited in claim 9, wherein the central room of the wrench head further includes a positioning recess in a wall thereof facing the central bore.
